(19) United States
(12) Patent Application Publication
(10) Pub. No.: US 2011/0050023 A1
(43) Pub. Date: Mar. 3, 2011

(54) MOTOR MAGNETIC POLE STRUCTURE

(75) Inventors: Jen-Chieh Wu, Sinjhuang City (TW); Chiang-Han Chen, Sinjhuang City (TW)

(73) Assignee: ASIA VITAL COMPONENTS CO., LTD., Sinjhuang City (TW)

(21) Appl. No.: 12/551,568

(22) Filed: Sep. 1, 2009

(51) Int. Cl. H02K 1/06

(52) U.S. Cl. 310/195

(57) ABSTRACT

A motor magnetic pole structure including a first seat having multiple first insulating arms and a second seat having multiple second insulating arms. Multiple first coils are wound on the first insulating arms and multiple second coils are wound on the second insulating arms. The first and second silicon steel seats overlap each other with the first and second insulating arms alternately positioned. In this case, the first and second coils wound on the first and second insulating arms are alternately positioned to intersect each other. The first and second silicon steel seats can assembled as necessary to enhance compatibility of the silicon steel seats and lower manufacturing cost. Moreover, the winding operation of the coils can be speeded.

### FIELD OF THE INVENTION

The present invention relates to a motor magnetic pole structure in which the winding operation of the coils can be more quickly completed. Moreover, the silicon steel seats can assembled as necessary to lower manufacturing cost and shorten working time.

### BACKGROUND OF THE INVENTION

The stators of the conventional inner rotor motors can be divided into three-pole type, four-pole type, six-pole type, eight-pole type, twelve-pole type, etc. enameled wire coils are wound on the poles or between the poles to form multiple sets of starter coils and drive coils. In early stage, the coils must be manually laboriously one-way wound on the poles one by one so that the processing efficiency is very low and the manufacturing cost is quite high.

Moreover, in a conventional stator structure, more than one set of coils is wound on each magnetic pole. When the number of the magnetic poles increases, the gaps between the magnetic poles will become smaller and smaller to limit the winding space for the coils and complicate the winding path. After the coils are wound on all the magnetic poles, the coils are very close to each other and tend to touch each other to cause a short circuit. Therefore, such structure can hardly include more coils with larger diameter to increase the torque of the motor. As a result, the efficiency of the motor as a whole is affected.

Also, the conventional stator includes many coils. Therefore, in manufacturing process, after the coils are completely wound, the stator will have a considerably large volume. In this case, the coils are apt to squash in to block the shaft hole. Under such circumstance, it is necessary to manually shift the coils outward. This procedure is troublesome and time-consuming. Furthermore, the coils are incompactly wound so that the coils tend to electrically touch the silicon steel plate and affect the operation of the motor. Besides, in the case that the number of the loops of the starter coil is equal to the number of the loops of the drive coil, the starting speed will be equal to the operating speed. However, not all the stators require that the operating speed be equal to the starting speed. In some cases, it is required that the starting speed be unequal to the operating speed. Therefore, the conventional stator can hardly meet the requirements of different products in speed.

### SUMMARY OF THE INVENTION

A primary object of the present invention is to provide a motor magnetic pole structure, which can be assembled in accordance with the application requirements of starter coils and drive coils.

A further object of the present invention is to provide the above motor magnetic pole structure in which the compatibility of the silicon steel seats is enhanced to lower manufacturing cost.

A still further object of the present invention is to provide the above motor magnetic pole structure in which the winding operation of the coils is speeded.

To achieve the above and other objects, the motor magnetic pole structure of the present invention includes a first seat and a second silicon steel seat. The first seat has multiple first insulating arms. A wall section with a certain height is disposed at an outer end of each first insulating arm. A recess is defined between each two adjacent first insulating arms. The second seat has multiple second insulating arms. A wall section with a certain height is disposed at an outer end of each second insulating arm. A recess is defined between each two adjacent second insulating arms. Multiple first coils are wound on the first insulating arms. Multiple second coils are wound on the second insulating arms. The first coils are ones of starter coils and drive coils. The second coils are the others of the starter coils and drive coils. The first and second silicon steel seats overlaps each other. The first insulating arms and the second insulating arms are alternately positioned. Also, the first and second coils wound on the first and second insulating arms are alternately positioned to intersect each other. Accordingly, the first and second silicon steel seats can assembled as necessary to enhance compatibility of the silicon steel seats and lower manufacturing cost. Moreover, the winding operation of the starter coils and drive coils can be speeded.

According to the aforesaid, the present invention has the following advantages:

1. The manufacturing cost of the present invention is lower.

2. The compatibility of the present invention is higher.

3. The winding operation of the coils of the present invention is speeded.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective view of the first seat of a first embodiment of the present invention;

FIG. 1B is a perspective view of the second seat of the first embodiment of the present invention;

FIG. 2 is a perspective assembled view of the first embodiment of the present invention;

FIG. 3A is a perspective view of the first seat of a second embodiment of the present invention;

FIG. 3B is a perspective view of the second seat of the second embodiment of the present invention; and

FIG. 4 is a perspective assembled view of the second embodiment of the present invention.

### DETAILED DESCRIPTION OF THE PREFERRED EMBODIMENTS

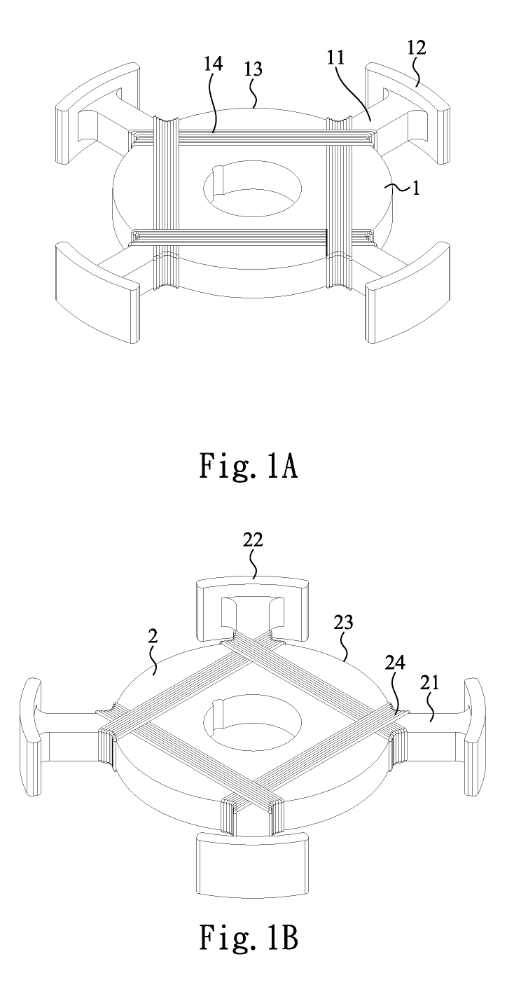

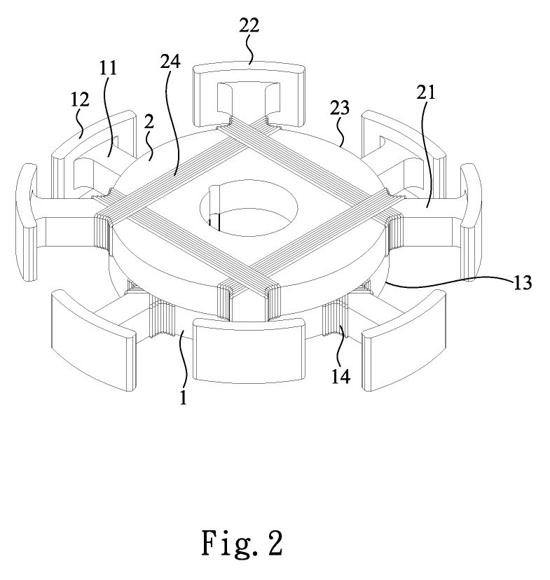

Please refer to FIGS. 1A, 1B and 2. According to a first embodiment, the motor magnetic pole structure of the present invention includes a first seat 1 and a second seat 2. The first seat 1 has multiple first insulating arms 11 horizontally outward extending from the first seat 1. A wall section 12 with a certain height is disposed at an outer end of each first insulating arm 11. A recess 13 is defined between each two adjacent first insulating arms 11. The second seat 2 has multiple second insulating arms 21 horizontally outward extending from the second seat 2. A wall section 22 with a certain height is disposed at an outer end of each second insulating arm 21. A recess 23 is defined between each two adjacent second insulating arms 21. Multiple first coils 14 are wound on the first insulating arms 11 of the first seat 1. Multiple second coils 24 are wound on the second insulating arms 21 of the second seat 2. The first coils 14 are ones of starter coils and drive coils. The second coils 24 are the others of the starter coils and drive coils.

The numbers of the first insulating arms 11 and the first coils 14 wound thereon and the numbers of the second insulating arms 21 and the second coils 24 wound thereon are variable as necessary. The present invention includes, but not limited to, four sets of first and second coils 14, 24 and six sets of first and second coils 14, 24 for illustration purposes. In this embodiment, there are four sets of first coils 14 and four sets of second coils 24. The first seat 1 has four first insulating arms 11 and the second seat 2 has four second insulating arms 21. Four sets of first coils 14 and four sets of second coils 24 are respectively disposed on the first and second silicon steel seats 1 and 2. The coils are wound in such a manner that the first coils 14 are wound from a beginning first insulating arm 11 and a recess 13 beside the beginning first insulating arm 11 to an adjacent first insulating arm 11 and another recess 13 beside the adjacent first insulating arm 11 until the first set of first coils 14 is completed. Then the coils are wound on the adjacent first insulating arm 11 and further wound to a next recess 13 beside a next adjacent first insulating arm 11 until the second set of first coils 14 is completed. After the second set of first coils 14 are completely wound, the coils are further wound from the first insulating arm 11 to a next adjacent first insulating arm 11 and to a next recess 13 beside the next adjacent first insulating arm 11 until the third set of first coils 14 is completed. After the third set of first coils 14 is completely wound, the coils are further wound from the first insulating arm 11 to the beginning first insulating arm 11 and to a next recess 13 beside the beginning first insulating arm 11 until the fourth set of first coils 14 is completed.

The second coils 24 of the second seat 2 are wound in a manner similar to that of the first coils 14. Four sets of second coils 24 are wound on the four second insulating arms 21 of the second seat 2. The four sets of second coils 24 are laid on the second seat 2. The first seat 1 with the first coils 14 overlaps the second seat 2 with the second coils 24. The first insulating arms 11 and the second insulating arms 21 are alternately positioned. Also, the first and second coils 14, 24 are alternately positioned to intersect each other. Accordingly, the first and second silicon steel seats 1 and 2 can assembled as necessary to enhance compatibility of the silicon steel seats and lower manufacturing cost. Moreover, the winding operation of the starter coils and drive coils can be speeded.

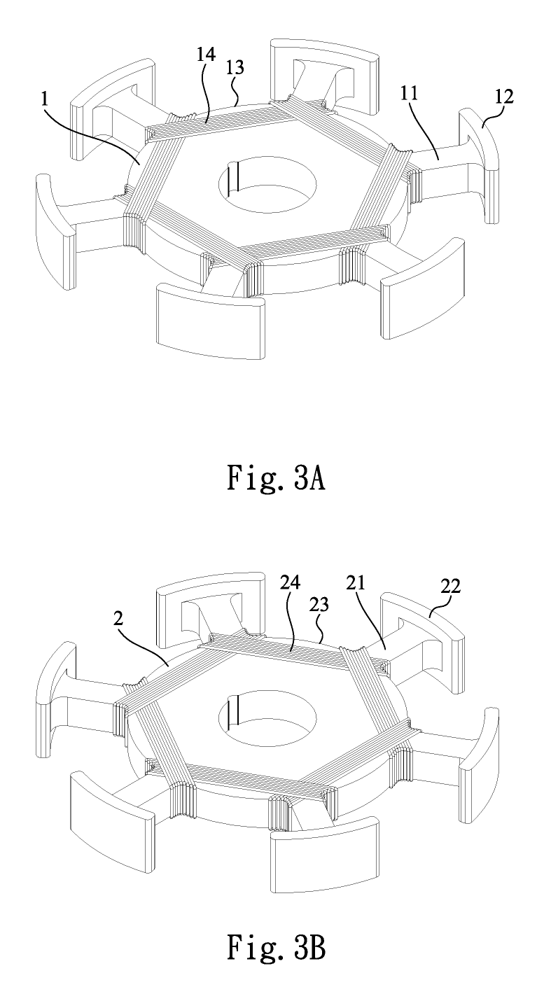

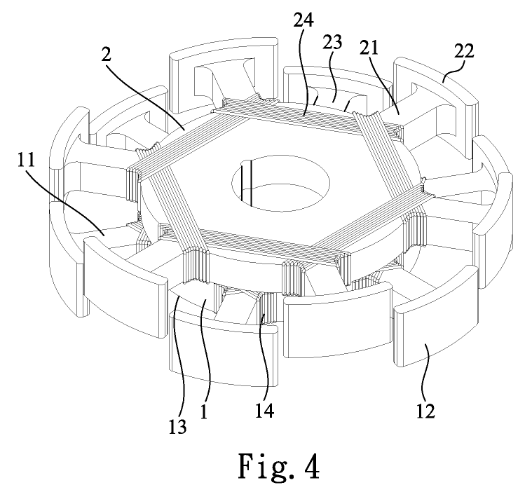

Please refer to FIGS. 3A, 3B and 4, which show a second embodiment of the present invention. In this embodiment, there are six sets of first coils 14 and second coils 24. The first seat 1 has six first insulating arms 11 and the second seat 2 has six second insulating arms 21. Six sets of first coils 14 and six sets of second coils 24 are respectively disposed on the first and second silicon steel seats 1 and 2. The six sets of coils are wound in a manner similar to that of the four sets of coils. The first coils 14 are wound from a beginning first insulating arm 11 and a recess 13 beside the beginning first insulating arm 11 to an adjacent first insulating arm 11 and another recess 13 beside the adjacent first insulating arm 11 until the first set of first coils 14 is completed. Then the first coils 14 are further one by one wound on the first insulating arms 11 respectively to complete all six sets of first coils 14. The second coils 24 of the second seat 2 are wound in a manner similar to that of the first coils 14. The second coils 24 are wound from a beginning second insulating arm 21 and a recess 23 beside the beginning second insulating arm 21 to an adjacent second insulating arm 21 and another recess 23 beside the adjacent second insulating arm 21 until the first set of second coils 24 is completed. Then the second coils 24 are further one by one wound on the second insulating arms 21 respectively to complete all six sets of second coils 24. The first seat 1 with the first coils 14 overlaps the second seat 2 with the second coils 24. The first insulating arms 11 and the second insulating arms 21 are alternately positioned. Also, the first and second coils 14, 24 are alternately positioned to intersect each other. Accordingly, the first and second silicon steel seats 1 and 2 can assembled as necessary to enhance compatibility of the silicon steel seats and lower manufacturing cost. Moreover, the winding operation of the starter coils and drive coils can be speeded.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A motor magnetic pole structure comprising a first seat having multiple first insulating arms and a second seat having multiple second insulating arms, multiple first coils being wound on the first insulating arms and multiple second coils being wound on the second insulating arms, the first seat and the second seat overlapping each other with the first and second coils alternately positioned and intersecting each other.

2. The motor magnetic pole structure as claimed in claim 1, wherein the first coils are ones of starter coils and drive coils, while the second coils are the others of the starter coils and drive coils.

3. The motor magnetic pole structure as claimed in claim 1, wherein the first seat has four first insulating arms.

4. The motor magnetic pole structure as claimed in claim 3, wherein four sets of first coils are wound on the first insulating arms of the first silicon steel seat.

5. The motor magnetic pole structure as claimed in claim 1, wherein the second seat has four second insulating arms.

6. The motor magnetic pole structure as claimed in claim 5, wherein four sets of second coils are wound on the second insulating arms of the second silicon steel seat.

7. The motor magnetic pole structure as claimed in claim 1, wherein the first seat has six first insulating arms.

8. The motor magnetic pole structure as claimed in claim 7, wherein six sets of first coils are wound on the first insulating arms of the first silicon steel seat.

9. The motor magnetic pole structure as claimed in claim 1, wherein the second seat has six second insulating arms.

10. The motor magnetic pole structure as claimed in claim 9, wherein six sets of second coils are wound on the second insulating arms of the second silicon steel seat.

11. The motor magnetic pole structure as claimed in claim 1, wherein the first insulating arms of the first seat and the second insulating arms of the second seat are alternately positioned.

12. The motor magnetic pole structure as claimed in claim 1, wherein a wall section with a certain height is disposed at an outer end of each of the first and second insulating arms.

13. The motor magnetic pole structure as claimed in claim 1, wherein a recess is defined between each two adjacent first insulating arms and a recess is defined between each two adjacent second insulating arms.
